(19) United States
(12) Patent Application Publication
(10) Pub. No.: US 2019/0297394 A1
(43) Pub. Date: Sep. 26, 2019

(54) ADDRESSING SCHEME FOR COMMUNICATING WITH SENSORS

(71) Applicant: CA, Inc., New York, NY (US)

(72) Inventors: Steven Greenspan, Scotch Plains, NJ (US); Maria C. Velez-Rojas, Santa Clara, CA (US); Serge Mankovskii, Morgan Hill, CA (US); Guy A. Di Lella, San Francisco, CA (US); Howard A. Abrams, San Mateo, CA (US); Navid Nader-Rezvani, Los Altos, CA (US); Mark Jacob Addleman, Oakland, CA (US); Otto Gabriel Berkes, Bedford Hills, NY (US); Paul Louis Pronsati, JR., Golden, CO (US)

(21) Appl. No.: 15/934,665

(22) Filed: Mar. 23, 2018

(51) Int. Cl. H04Q 9/00; H04L 29/12

(52) U.S. Cl. CPC H04Q 9/00; H04W 84/18; H04L 61/6081; H04L 61/2076

(57) ABSTRACT

An apparatus includes a sensor circuit and a wireless communication interface. The sensor circuit may periodically sense a value for a particular environmental variable. The wireless communication interface may update a dynamic address for the apparatus based on the periodically sensed value, and receive a query from a base station. The query may include a conditional address corresponding to the particular environmental variable. In response to a first comparison of the conditional address to a current dynamic address, the wireless communication interface may send a reply to the base station indicating whether the query has matched for the apparatus. The reply to the query may be performed without requesting a reading of the particular environmental variable from the sensor circuit.

### BACKGROUND

### Technical Field

Embodiments described herein are related to the field of wireless communication, and more particularly to the implementation of a communication protocol for addressing sensor nodes.

### Description of the Related Art

Various types of sensor nodes may be utilized for a variety of applications. For example, in an office building, many smoke and/or fire sensor nodes may be placed throughout the building to detect a fire and sound an alarm and enable a sprinkler system. In an agricultural setting, temperature and moisture sensor nodes may be placed throughout fields of crops to measure soil water content and ambient heat to help determine when a particular field needs to be watered. Wireless communication between the sensor nodes and a base station may be used when running wires may be burdensome, impractical, and/or costly. Wireless sensor nodes may communicate to the base station via standardized protocols such as Wi-Fi, Bluetooth, and ZigBee, or may be a proprietary protocol developed for a particular purpose.

### SUMMARY

Various embodiments of a sensor network are disclosed. Broadly speaking, an apparatus, is contemplated in which the apparatus includes a sensor circuit and a wireless communication interface. The sensor circuit may be configured to periodically sense a value for a particular environmental variable. The wireless communication interface may be configured to update a dynamic address for the apparatus based on the periodically sensed value, and to receive a query from a base station. The query may include a conditional address corresponding to the particular environmental variable. In response to a first comparison of the conditional address to a current dynamic address, the wireless communication interface may also be configured to send a reply to the base station indicating whether the query has matched for the apparatus. The reply to the query may be performed without requesting a reading of the particular environmental variable from the sensor circuit.

In another embodiment, another apparatus is contemplated in which the apparatus includes a processor circuit and a wireless communication interface. The processor circuit may be configured to generate a first conditional address based on a value for a particular environmental variable, and to generate a second conditional address based on a value for a different environmental variable. The wireless communication interface may be configured to transmit a query that includes the first conditional address, the second conditional address, and at least one comparator value indicating a type of comparison operation to be performed to determine whether the query is considered a match.

### BRIEF DESCRIPTION OF THE DRAWINGS

The following detailed description makes reference to the accompanying drawings, which are now briefly described.

FIG. 1 illustrates a block diagram of an embodiment of a wireless sensor and base station.

FIG. 2 shows a diagram of an embodiment of a wireless sensor system for an agricultural application.

FIG. 3 depicts a block diagram of an embodiment of a wireless sensor that utilizes dynamic addresses.

FIG. 4 illustrates tables demonstrating an example scheme for generating a dynamic address.

FIG. 5 shows tables demonstrating an example of a comparison of a dynamic address to a conditional address.

FIG. 6 depicts tables demonstrating an example of a comparison of two dynamic addresses to a compound conditional address.

FIG. 7 illustrates an embodiment of a state diagram used in comparing two dynamic addresses to conditional addresses in a query.

FIG. 8 shows a flow diagram for an embodiment of a method for operating a wireless sensor with dynamic addressing.

FIG. 9 presents a flow diagram for an embodiment of a method for generating a compound conditional address by a base station.

While the embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION

In the previously disclosed agricultural example, wireless sensor nodes may be powered by batteries, solar, wind, or any combination thereof. Such power sources may provide a limited supply of power. Each sensor reading and each communication with the base station consumes a portion of the limited power supply, so, to conserve power, sensor nodes may enter a reduced power state after performing a sensor reading or a wireless communication. Minimizing a number of times each sensor node communicates with the base station may reduce power consumption. The present disclosure describes techniques for reducing a number of interactions between the base station and each sensor node.

The embodiments illustrated and described herein may employ CMOS circuits. In various other embodiments, however, other suitable technologies may be employed.

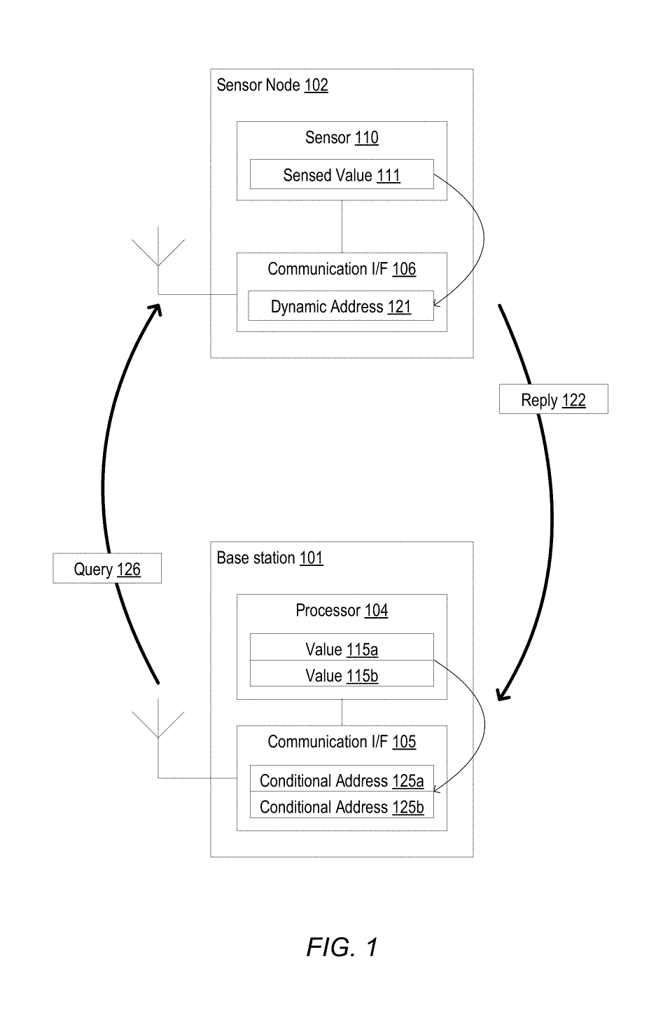

A block diagram of an embodiment of a sensor node and base station is shown in FIG. 1. The illustrated embodiment includes base station 101 communicating with sensor node 102. Base station 101 includes processor 104 and communication interface (I/F) 105. Sensor node 102 includes sensor 110 and communication interface (I/F) 106. Base station 101 and sensor node 102, in the illustrated embodiment, communicate using a wireless radio frequency (RF) protocol, although other wired communication protocols are also contemplated.

Sensor Node 102, in the illustrated embodiment, uses sensor 110 to measure an environmental variable and may communicate information regarding measurements to base station 101 using communication interface 106. Communication interface 106 may use one or more addresses to determine if a received message is directed to sensor node 102. Sensor 110 may include any suitable circuits for measuring a relevant environmental variable. Environmental variables may include, for example, temperature, humidity, wind speed, luminance, velocity, direction, mass, pressure, and other physical conditions that may be measured by a sensor circuit. In some embodiments, sensor 110 may include circuits for measuring more than one condition, and/or sensor node 102 may include more than one sensor circuit. Sensor 110 may perform a measurement in response to a query received via communication interface 106. Alternatively, or in addition to receiving a query, sensor 110 may make periodic measurements and save a most recent measurement as sensed value 111. In various embodiments, sensor node 102 may receive a request from base station 101 for data related to sensed value 111, or may periodically send such data to base station 101. Communication interface 106 also generates dynamic address 121 that is based on sensed value 111. As used herein, a “dynamic address” refers to an address in a communication network that may change over time. Dynamic address 121 may, therefore, be updated after each update of sensed value 111, thereby providing a reference to a current value of the sensed condition. Communication interface 106 uses dynamic address 121 to determine when certain received messages are directed to sensor node 102.

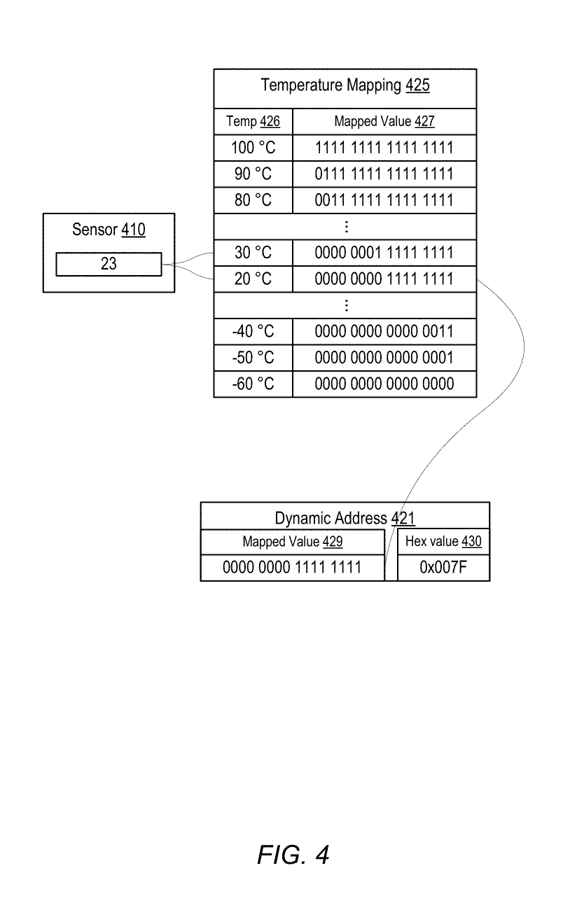

In the illustrated embodiment, base station 101 communicates with sensor node 102 to retrieve information related to sensor readings by transmitting messages to (e.g., query 126) and receiving messages from (e.g., reply 122) sensor node 102. In some embodiments, base station 101 communicates with additional sensor nodes as well as sensor node 102, using an address to identify a particular sensor node. A sensor node matching the address may respond by, for example, sending a value related to a sensed reading. In some cases, processor 104 determines one or more values, such as values 115a and 115b, to use as part of a conditional address, such as, for example, conditional addresses 125a and 125b. A “conditional address,” as used herein, refers to a value that may be specified in a query that corresponds to a particular value of a respective environmental variable. For example, a humidity sensor may measure values from 0% to 100% humidity in an air sample. A conditional address to address the humidity sensor may range from 50000 to 50100. A conditional address of 50033 may, therefore, be used to query for sensor nodes with a humidity value of 33%. In some cases, the “conditional address” may include additional information in addition to the environmental variable value, including comparison type and the identity of the variable. Additional details regarding information included in conditional and dynamic address are disclosed below, for example, in regards to descriptions of FIGS. 4 through 6.

Referring again to FIG. 1, processor 104 may send value 115a to communication interface 105 which then generates conditional address 125a. Value 115a may correspond to a particular value for an environmental variable that is sensed by sensor 110, such as, e.g., temperature. Processor 104 may send additional information to communication interface 105, such as a type of data represented by value 115a and a particular condition for determining a match to conditional address 125a. Communication interface 105 combines the received information with value 115a to generate query 126. Communication interface 105 then transmits query 126, which includes conditional address 125a and associated conditions for matching conditional address 125a, to any sensor node in range of base station 101. For example, query 126 may correspond to a request to sensor nodes with a temperature value greater than 27° C.

Continuing the example, communication interface 106 receives query 126 and makes a determination if conditions included in query 126 are met by sensor node 102. To make the determination, communication interface compares conditional address 125a included in query 126 to dynamic address 121. If dynamic address 121 meets the conditions indicated in query 126, in this example, a temperature value greater than 27° C., then communication interface 106 treats query 126 as a message directed to sensor node 102, and transmits reply 122. In various embodiments, reply 122 may include the most recent sensed value 111, an indicator if the identity of sensor node 102, or a combination thereof. Otherwise, if for example, sensed value 111 corresponds to a temperature value of 25° C., then communication interface 106 ignores query 126.

After completing a measurement, updating sensed value 111, and sending the updated sensed value 111 to communication interface 106, in some embodiments, sensor 110 may enter a reduced power mode from a first power mode. While in the reduced power mode, sensor 110 may be incapable of making a measurement. In the reduced power mode, voltage to one or more sub-circuits, or voltage to all circuits, in sensor 110 may be reduced to any suitable voltage level, including zero volts. To reply to query 126, communication interface may include the last sensed value 111 received from sensor 110 in reply 122, without causing sensor 110 to re-enter the first power mode and make another measurement. This may allow sensor node 102 to remain in a reduced power mode while also remaining receptive to queries from base station 101.

For some wireless sensor nodes, a major source of power drainage may be listening for a query rather than reading a sensor or responding to a query. In some embodiments sensor node 102 may not know exactly when a next query will be sent. Sensor node 102, may therefore periodically enable communication interface 106 to sense a communication from base station 101, or may keep communication interface 106 active continuously. Such a process may result in wasted power if base station 101 is not sending a query. Base station 101 may reduce wasted energy by adding, to query message 126, an indication of an amount of time until a next query will be transmitted. In response to receiving this indication, sensor node 101 may add, to reply 122, a confirmation of the proposed amount of time, or a modified proposal. The modified proposal may be for a longer amount of time if a current status for a power supply of sensor node 102 is low. In other cases, the modified proposal may be for a shorter amount of time if sensor node 102 determines that recent values sensed by sensor 110 are varying by more than a predetermined threshold.

It is noted that FIG. 1 is merely an example for demonstrating disclosed concepts. Only components necessary to the illustrate the disclosed concepts are shown in FIG. 1. Additional and/or different components may be included in other embodiments. For example, additional sensor nodes may be included, or sensor node 102 may include additional sensor circuits.

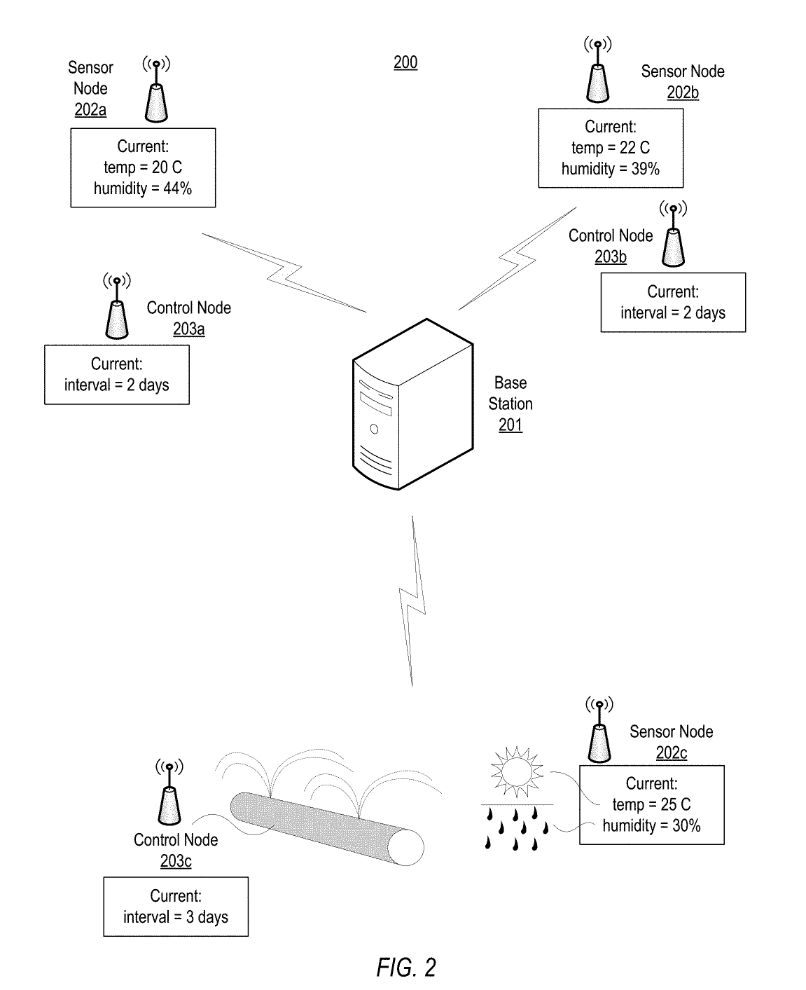

Turning to FIG. 2, an example of a wireless sensor system is shown. A system for watering vegetation is presented, although the disclosed concepts may be applicable to various other uses. System 200 includes base station 201 wirelessly linked to three sensor nodes 202a-202c (collectively referred to as sensor nodes 202), and three control nodes 203a-203c (collectively referred to as control nodes 203). In the illustrated embodiment, system 200 is used to monitor selected weather conditions, temperature and humidity in this example, and control an amount of water flow through an irrigation system in response. System 200 may be used for irrigating various crops across multiple fields.

Each sensor node 202 in the example includes two sensor circuits, one for monitoring temperature and another for monitoring humidity. Measurements are made periodically and stored in a suitable memory (volatile or non-volatile) until the sensed values are requested by base station 201. After completing a measurement, each of the sensor circuits enters a reduced power state to conserve energy. In addition to storing each sensed value, each sensor node 202 creates a respective dynamic address for each sensed value, in which the dynamic address is indicative of the sensed value. These dynamic addresses may be used to determine if a particular sensor node 202 should reply to a query sent by base station 201.

Base station 201 generates one or more conditional addresses to identify one or more sensor nodes 202 that match the generated condition. A conditional address includes a value for temperature or humidity with a corresponding comparator value. As used herein, a “comparator value” or “comparison value” refers to a value that identifies a type of comparison to be performed, which may produce a Boolean result (one that is either “true” or “false”). Comparator values may be indicative of, for example, “greater than,” “less than,” “equal to,” “not equal to,” or other similar comparison operations. A query, therefore, may correspond to “temperatures greater than 20° C.” or “humidity less than 35%.” In these two examples, the respective comparator values would be “greater than” and “less than.” Base station 201 generates a query based on one or more conditional addresses. The query, for example, may also be directed to sensor nodes 202 with “sensed temperatures greater than 20° C.” and “sensed humidity less than 35%.” This is an example of a compound query—one that involves more than one comparison operation.

Queries and conditional addresses may be generated by base station 201 based on any of a variety of inputs. For example, a particular query and the included conditional addresses may be based on data received in response to previously transmitted messages, forecasted/predicted data received from a network connection, user input, a software program running on base station 201, sensors coupled directly to base station 201, or any other suitable source. Base station 201 transmits the generated query to sensor nodes 202.

Some or all of sensor nodes 202 may receive the transmitted query and compare the conditional addresses to respective dynamic addresses of each sensor node 202. In the illustrated example, sensor node 202a has a temperature of 20° C. and a humidity of 44%. Sensor node 202a, therefore, does not match either conditional address included in the query, and may ignore the query. Sensor node 202b has a temperature of 22° C. and a humidity of 39%. Sensor node 202b matches the conditional address related to temperature, but does not match he conditional address related to humidity, and may also ignore the query. Sensor node 202c has a temperature of 25° C. and a humidity of 30%. Sensor node 202c, therefore, matches both conditional addresses and may then respond to the query by, for example, sending the last stored values for temperature and humidity to base station 201. As part of this response, sensor node 202c may also send an indication of an identifier for sensor node 202c, such as, for example, a static address assigned, within system 200, only to sensor node 202c.

It is noted that the example query was directed to sensor nodes 202 with “sensed temperatures greater than 20° C.” and “sensed humidity less than 35%.” As another example, a query may be directed to sensor nodes 202 with “sensed temperatures greater than 20° C.” or “sensed humidity less than 35%.” With such a query, sensor node 202b may also respond in addition to sensor node 202c.

In some embodiments, base station 201 may set a time period for receiving a reply to a transmitted query. For example, upon completing a transmission of a query, base station 201 may enable a timer circuit that asserts a signal upon its count value reaching a particular value. In response to the assertion of the signal, the base station determines how many sensor nodes 202 responded. If no sensor nodes 202 responded, then base station 201 may retransmit the last query or create a new one.

In response to receiving a reply from one or more sensor nodes 202 before the time period expires, base station 201 may determine a location or an identity of the sensor node (or nodes) 202 that responded. Returning to the example, after sensor node 202c responds with the stored values for temperature and humidity, base station 201 determines a location of sensor node 202c. If. for example, sensor node 202c includes a static address, then base station 201 may use stored data, such as, e.g., a list of sensor nodes 202, to identify in which field the sensor is located. With the location known, base station 201 may then generate a command message to be transmitted to one or more control nodes 203 located nearest to sensor node 202c. In the illustrated example, control node 203c is the closest and may receive the command message from base station 201 instructing control node 203c to, for example, increase an amount, a duration, a frequency, or a combination thereof, of water flow to provide additional irrigation in the vicinity of sensor node 202c. Instructions included in the command message may be based on the values received from sensor node 202c, thereby allowing base station 201 to select a response that is suitable for the conditions reported by sensor node 202c.

It is noted that, in the illustrated example, base station 201 received data only from the sensor node that matched the conditions included in the query, i.e., sensor node 202c. In addition to the potential benefit of reduced power consumption described in regards to FIG. 1, the disclosed concepts may also reduce an amount of messages and/or data received by base station 201. By reducing the number of messages base station 201 receives, and therefore reducing the amount of data to process, base station 201 may be capable of providing a faster response to control nodes associated with the sensor nodes that meet the conditions of the query, thereby improving performance and potentially reducing an amount of RF signaling noise to other RF networks in the vicinity.

It is also noted that the system illustrated in FIG. 2 is merely an example. Although system 200 is illustrated as a system for watering vegetation, similar systems could be adapted for various other uses, such as, for example, security systems, traffic control, weather stations, and the like, by utilizing appropriate types of sensor nodes. Although three sensor nodes and three control nodes are shown, any suitable number of either node may be included in other embodiments.

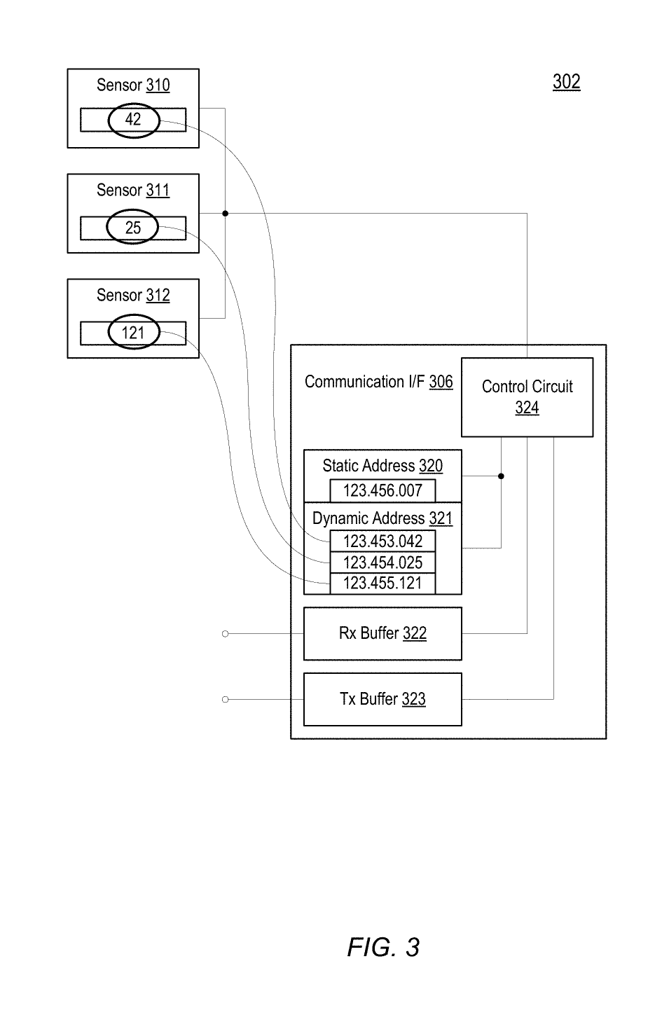

Moving to FIG. 3, features of an embodiment of a sensor node, such as may be used in system 200, are depicted. The illustrated sensor node 302 includes communication interface (I/F) 306 coupled to three sensor circuits, sensor 310, sensor 311, and sensor 312. Communication interface 306 includes a registers for static address 320, as well as dynamic addresses 321. Communication interface 306 further includes receive (Rx) buffer 322, transmit (Tx) buffer 323, and control circuit 324.

In the illustrated embodiment, sensors 310-312 each measure a respective environmental variable, such as described above in FIG. 1, in response to a particular trigger. In various embodiments, the trigger may correspond to a request from communication interface 306, an assertion of a signal from a timer circuit, or any other suitable trigger mechanism. The respective measured values are stored in respective registers or memory locations as shown in FIG. 3. Each measured value is also sent to control circuit 324. After storing and sending the measured values, each sensor 310-312 may enter a reduced power state.

Control circuit 324 receives the measured values and uses these values to create respective a dynamic address 321 for each value. As shown in the embodiment of FIG. 3, sensor 310 generates a value of 42, which control circuit 324 uses to generate a dynamic address of 123.453.042. In this example, the measured value of “42” is used to generate the last three digits of the dynamic address, “042.” In other embodiments, control circuit 324 may utilize an algorithm, look-up table, equation, or other process to convert the measured value into the address. Control circuit 324 adds the value of “042” to a value representing the particular environmental variable, “453.” Returning to the watering example of FIG. 2, “453” may correspond to humidity and sensor 310, therefore, corresponds to a humidity sensor. Similarly, sensor 311 may correspond to a temperature sensor with a last measured value of 25° C., and sensor 312 may correspond to a photo-sensor that last measured an amount of sunlight as 121 Lux. Control circuit 324 generates dynamic addresses corresponding to temperature and illuminance, using identifying values of “454” for temperature and “455” for illuminance. In other embodiments, such as, for example, a sensor node with a single sensor type (e.g., a temperature sensor) the value corresponding to the particular environmental variable may be omitted or replaced with another type of value.

In some embodiments, the value of “123” at the beginning of each address may correspond to a particular base station, such that all sensor nodes included in a particular base station's network use the same first three digits. In other embodiments, the first three digits may be assigned by a particular sensor node type, by a manufacturer, or by any other suitable convention.

Communication interface 306 also includes static address 320, with a value of “123.456.007.” In this case, “456” may be reserved for static addresses, and “007” may identify sensor node 302 as the seventh sensor node in a particular sensor network, or may simply be randomly assigned. Static address 320 may be used by a base station to address sensor node 302 specifically, without sensor node 302 matching a conditional address.

Sensor node 302 may receive, from a base station, a query that includes one or more conditional addresses. After receiving a query from a base station via receive buffer 322, control circuit 324 extracts the one or more conditional addresses and compares each one to an appropriate respective dynamic address. For example, a conditional address that is directed to temperature is compared, using a condition included in the conditional address, to the dynamic address that represents temperature, i.e., “123.454.025.” If a match occurs, then control circuit 324 may respond, using transmit buffer 323, to acknowledge the match. In various embodiments, the response may be a simple acknowledgement that sensor node 302 matched the conditional address or may include the currently stored sensor value for the environmental variable in the conditional address, e.g., the temperature value of 25. The response may also include the static address or another value indicative of the identity of sensor node 302, thereby distinguishing the response as being from sensor node 302 and not from another sensor node in the network. In some embodiments, the response may include some or all of the other currently stored sensor values. Communication interface may respond without requesting a new sensor reading from any of sensors 310-312.

It is noted that sensor node 302 of FIG. 3 is merely one example used to demonstrate the disclosed concepts. In various embodiments, functional circuits may differ per requirements for the particular embodiment. For example, in some embodiments, more or fewer than three sensor circuits may be included. The address values in FIG. 3 are shown with nine digits. Addresses with various other numbers of digits may be utilized in other embodiments. In addition, one method of encoding the sensor readings in to the dynamic addresses is shown. Other methods, however, are known and contemplated for use with the embodiments disclosed herein.

FIG. 4 illustrates another method for encoding sensor readings into a dynamic address. In FIG. 3, a dynamic address was created by using a particular sensor value as a portion of an address. The illustrated embodiment of FIG. 4 uses a mapping table to determine a dynamic address from a particular sensor reading. FIG. 4 includes several elements that may be included in a sensor node, such as, for example sensor node 102 or 202 in FIGS. 1 and 2 respectively. The example of FIG. 4 utilizes temperature mapping table 425 to convert a value from sensor 410 into dynamic address 421.

In the illustrated embodiment, sensor 410 performs a temperature measurement and generates a temperature value, in this example, a value of “23.” A control circuit in the sensor node receive this value and use it to reference a temperature value in the temp 426 column of temperature mapping table 425. The value of 23 lies between entries for 20° C. and 30° C. In various embodiments, one of these two entries may be selected by rounding the measured value up or down, or by truncating the measured value. In the current example, the measured value is rounded down to the 20° C. entry. The selected mapped value 429 is used to generate the dynamic address 421. The binary value for mapped value 429 may be represented by the hexadecimal address value 430 of 0x007F and stored in a register or other memory location within a particular sensor node. In some embodiments, a type indicator may be added to dynamic address 421 to indicate a type of environmental variable the address is based on, such as, in this example, temperature.

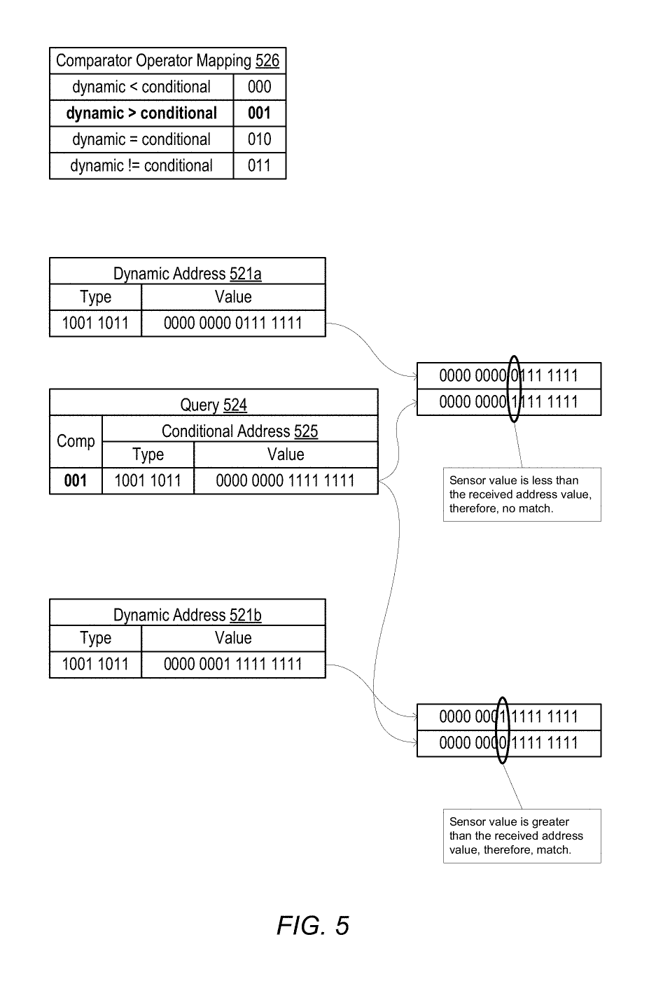

Any suitable mapping process may be used to generate mapped values 427. In the illustrated embodiment, the algorithm starts with a minimum value for the temperature value of −60° C. corresponding to “0000 0000 0000 0000” and assigns values in 10° C. increments up to a maximum value of 100° C. For each 10° C. increment, a least significant “0” is replaced by a “1.” The more consecutive “1's” in the mapped value 427, the higher the temperature. While such a mapping construct may not utilize all potential values of a 16 bit binary number, this mapping may result in more simplified circuits for comparing the dynamic address 421 to a received conditional address as compared to a straight binary encoding of the measured temperature value. FIG. 5 below will provide an example comparison.

It is noted that FIG. 4 is an example for demonstrating concepts disclosed herein. The presented tables and data are used as examples only and are not intended to be limiting. Various other mapping constructs are known and contemplated for use. Although a 16 bit dynamic address value is shown, any suitable size of address may be used in various embodiments.

Moving now to FIG. 5, an example of a query that compares a dynamic address to a conditional address is shown. The address format used in the example of FIG. 5 is similar to the format presented in FIG. 4. The tables in FIG. 5 demonstrate two separate comparisons of a dynamic address to a conditional address. Query 524 may be sent by a base station and received by two sensor nodes. A first comparison is shown between dynamic address 521a and conditional address 525 and a second is shown between dynamic address 521b and conditional address 525. Comparator operating mapping 526 illustrates one embodiment of a mapping of comparative conditions to comparator values included in a query. Dynamic addresses 521a and 521b correspond to stored measurement values from respective sensor circuits, such as may be included in respective sensor nodes 202 in system 200 of FIG. 2. Similarly, conditional address 525 represents a conditional address included in a transmitted query from a base station, such as base station 201 in system 200.

In the first example, a first sensor node includes dynamic address 521a and receives conditional address 525 in a query from a base station. In the illustrated embodiment, the dynamic and conditional addresses include a type identifier to indicate a type of environmental variable associated with the addresses. Dynamic address 521a includes a type of “1001 1011” which may correspond to any particular environmental variable, such as, for example, any of temperature, humidity, wind speed, luminance, velocity, direction, mass, pressure, or other physical condition, and includes a measured value for the sensed environmental variable. Conditional address 525 has a same type, resulting in the first sensor node comparing the respective values for each address. Query 524 includes conditional address 525 as well as a comparator value (Comp) to indicate a condition of the comparison that results in a match. Comparator operating mapping 526 includes four different types of comparisons. The comparator value of “001” in query 524 corresponds to a match occurring when the dynamic address value is greater than the conditional address value. The value of dynamic address 521a is “0000 0000 0111 1111,” which, as described above in regards to FIG. 4, may be a rounded or truncated value based on a measured value from a sensor circuit. The value of conditional address 525 is “0000 0000 1111 1111” which is greater than the dynamic value. Dynamic address 521a, therefore, does not match the received query.

In the second example, a second sensor node receives query 524. The second sensor node includes dynamic address 521b which also includes a type of “1001 1011,” resulting in another comparison with conditional address 525. The second sensor node performs a “greater than” comparison between the value of dynamic address 521b and the value of conditional address 525. In this case, the value of dynamic address 521b is “0000 0001 1111 1111,” which is greater than the value of conditional address 525, resulting in the second sensor node matching query 524. In response to the match, the second sensor node may reply to query 524 with the value of dynamic address 521b. In some embodiments, a stored value of the actual sensed measurement rather than the rounded/truncated value used in dynamic address 521b may be sent in the reply. In addition, the second sensor node may send a value indicative of the identity of the second sensor node.

It is noted that the address format, including using an increase in a number of “1” digits in the respective values, may allow for a decreased complexity in the circuits of the sensor nodes. More specifically, circuits used to compare dynamic values to conditional values may be implemented in combinational logic, and in some embodiments, may not require a clock source to produce a match indication, as opposed to circuits used to compare traditional binary encoded numbers. In some embodiments, this reduced complexity may result in a reduction of power consumption and/or a decrease in a time to perform the match determination.

It is also noted that FIG. 5 is merely an example of comparisons that may be performed by embodiments as presented in this disclosure. The addresses are simplified to provide clear descriptions of the disclosed concepts. In other embodiments, the address formats may be different, including using a different number of bits. Although four operator mappings are illustrated, any suitable number of operator mappings may be implemented in some embodiments.

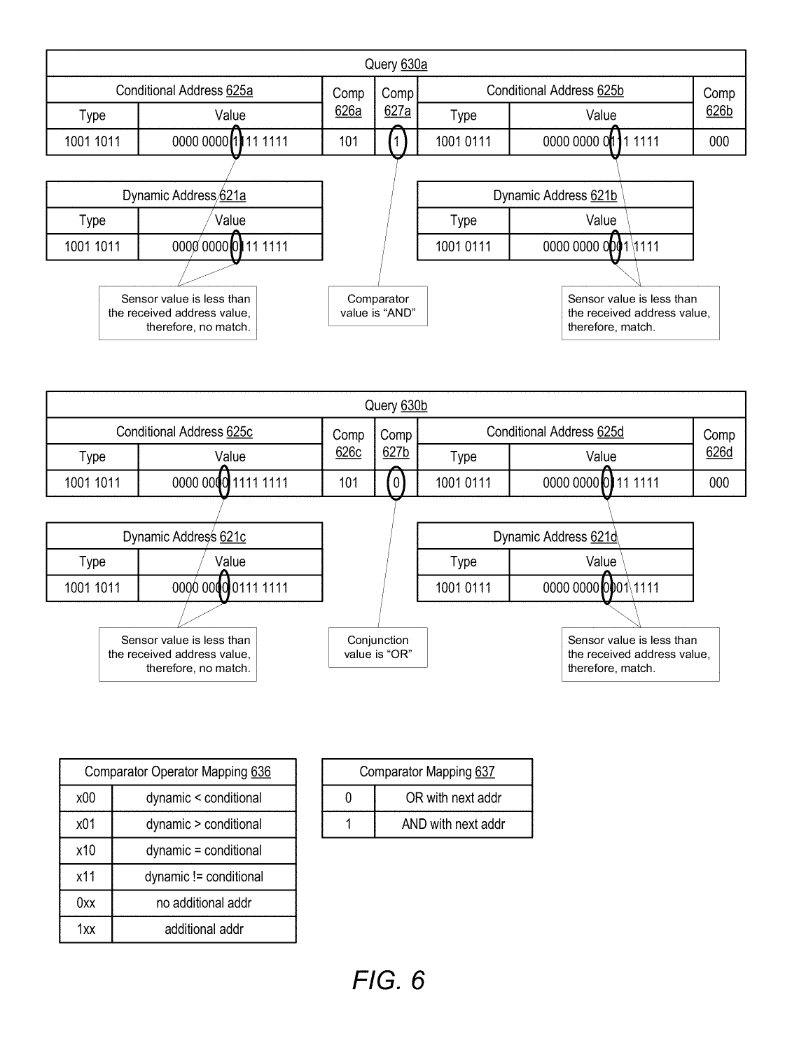

Turning to FIG. 6, an example is depicted of a compound query. A “compound query,” as used herein, refers to queries that each include at least two conditional address and related conditions associated with these addresses. Two examples are presented in which a compound query with two conditional addresses is transmitted by a base station and received by a sensor node with two sensor circuits. The first example includes query 630a, with conditional addresses 625a and 625b, and dynamic addresses 621a and 621b. The second example includes query 630b, with conditional addresses 625c and 625d, to be compared to dynamic addresses 621c and 621d. In some embodiments, the two example queries may represent two separate queries received by a single sensor node at different points in time.

Each of queries 630a and 630b are created using two conditional addresses. Referring to query 630a, both conditional addresses 625a and 625b include address bits representing type and value. Query 630a adds comparator value (Comp) 626a for use with conditional address 625a and comparator value 626b for use with conditional address 625b. Query 630a also includes an additional bit representing comparator value 627a that indicates a particular Boolean operator to be used. For example, an “AND” Boolean operator may indicate that conditional addresses 625a “AND” 625b must match for the query to be a match. Similarly, an “OR” Boolean operator may indicate that either conditional address 625a “OR” 625b needs to match to make the query true. Comparator value 626a has a value of “101.” Referring to comparator operator mapping table 636, the leading “1” in this comparator value indicates an additional conditional address is included in query 630a. This leading “1” also indicates that the next address bit represents the comparator value, “1” in query 630a, for linking conditional addresses 625a and 625b. Comparator value 627a may be determined using comparator mapping table 637. In the example of query 630a, the comparisons of both conditional address 625a AND 625b must be true for query 630a to be true.

The sensor node, after receiving query 630a, determines that the type of conditional address 625a matches the type of dynamic address 621a, and that the value of “101” for comparator value 626a indicates that the dynamic address must be greater than the conditional address for conditional address 625a to match. The value of dynamic address 621a, however, is less than the value of conditional address 625a, and conditional address 625a is, therefore, false, and not a match.

Moving to the second conditional address in query 630a, the type of conditional address 625b matches the type of dynamic address 621b, and the value of “000” for comparator value 626b indicates that the dynamic address must be less than the conditional address for a match. The value of dynamic address 621b is less than the value of conditional address 625b, and, therefore, conditional address 625b is true, and therefore, a match. Since comparator value 627a indicates an “AND” operation, however, query 630a results in no match to the current dynamic addresses 621a and 621b, and the sensor node may ignore query 630a.

In the second example, which may occur at a later point in time, the sensor node receives query 630b. Again, the types of conditional address 625c and dynamic address 621c match and the value of “101” for comparator value 626c indicates that the dynamic address must be greater than the conditional address for a match. As in the first example, the value of dynamic address 621c is lower than the value of conditional address 625c, and conditional address 625c is again false.

Moving to the second conditional address in query 630b, the type of conditional address 625d matches the type of dynamic address 621b. The value of “000” for comparator value 626b indicates a “less than” operation. The value of dynamic address 621b is less than the value of conditional address 625d, resulting in a true condition for conditional address 625d. Comparator value 627b in query 630b is “0,” which, as determined from comparator mapping table 637, corresponds to an “OR” operation. Since an “OR” operation, as opposed to an “AND” operation, is used, the one true result for conditional address 625d results in a match for query 630b. The sensor node may respond accordingly.

It is noted that the use of the comparator value may be extended to include more than two conditional addresses in a single query by setting the leading bit in comparator value 626b or 626d to “1.” In addition, more than one address bit may be used for the comparator value, allowing for more operations than “AND” and “OR.” Additional bits in the queries may be used, for example, to include parenthetical operators to help construct more complex queries. An example of such a query may be in the form of: condition A AND (condition B OR condition C), or (condition A AND condition B) OR condition C.

It is also noted that the method illustrated in FIG. 6 is one example. The address formats are presented as one example and variations are contemplated in other embodiments. Additional or different comparator operator mappings may be used in other embodiments.

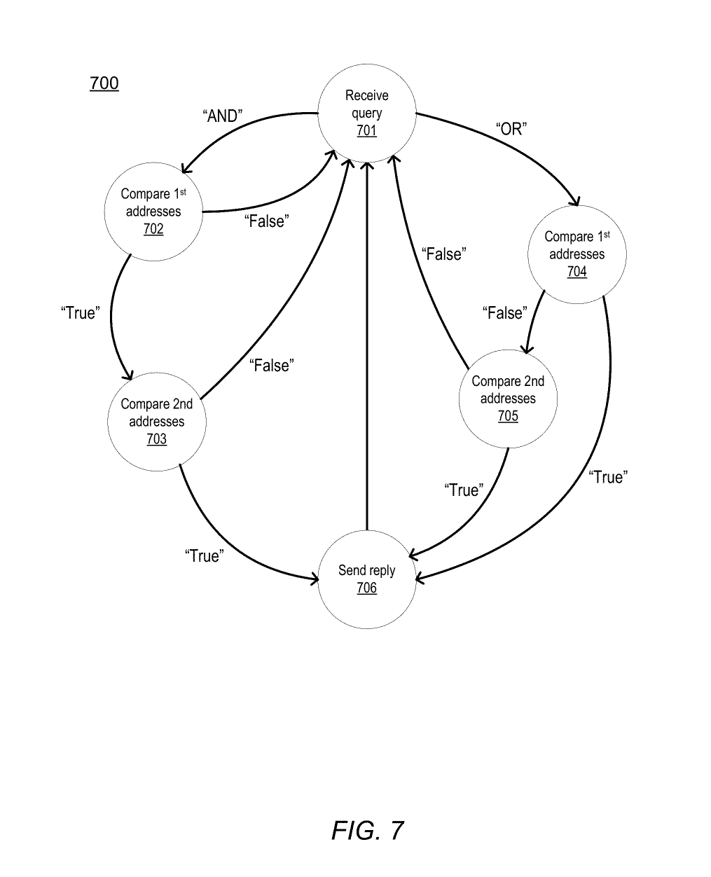

Moving to FIG. 7, an embodiment is illustrated of a flow diagram of states used when comparing two dynamic addresses to two conditional addresses in a query. State diagram 700 may be applicable to control logic in a sensor node, such as, for example, control circuit 324 in sensor node 302 in FIG. 3. In various embodiments, state diagram 700 may be implemented as a hardware state machine, program instructions executed by a processor, or a combination of thereof. State diagram 700 includes six states, 700 through 706.

In the illustrated embodiment, state diagram 700 is employed when a sensor node receives a query that includes two or more conditional addresses. After receiving the query, in state 701, control circuit 324 determines a comparator value for relating two conditional addresses. Control circuit 324 may extract a comparator value after determining that the query includes at least two conditional addresses. After extracting the comparator value, control circuit 324 moves to either state 702 or 704 depending on the operation indicated by the comparator value. An “AND” operator moves control circuit 324 to state 702, while an “OR” operator moves control circuit 324 to state 704.

In state 702, control circuit 324 compares a first conditional address to a corresponding dynamic address. As disclosed above, for example in regards to FIGS. 5 and 6, a conditional address may be compared to a dynamic address with a same type. Values for each of the conditional address and dynamic address are compared to determine if a condition included in the conditional address is true. If the comparison is true, then control circuit 324 enters into state 703. Otherwise, a false result causes control circuit 324 to return to state 701 and await a next query.

In state 703, control circuit 324 compares a second conditional address to a second corresponding dynamic address. Again, a value for the conditional address is compared to a value of a dynamic address of the same type to determine if a condition included in the second conditional address is true. If the condition is true, then the query matches for sensor node 302 and control circuit 324 moves to state 706 to send a reply. Otherwise, control circuit 324 returns to state 701 to await a next query.

If control circuit 324 enters state 704 as a result of detecting an “OR” operation in state 701, then control circuit 324 enters state 704 and performs a comparison of the conditional address and the dynamic address, similar to state 702. If, however, the comparison is true, control circuit 324 moves to state 706 to send a reply, regardless of the result of the second conditional address. If the comparison is false, then control circuit 324 moves to state 705 to compare the second conditional address.

In state 705, control circuit 324 performs a comparison of a second conditional address to a second dynamic address. If the comparison is false, then both the first and second conditional address have failed to match the dynamic addresses of sensor node 302 and control circuit 324 returns to state 701 to await a next query. Otherwise, if the comparison of the second conditional address and the second dynamic address is true, then control circuit 324 moves to state 706 to send a reply.

Control circuit 324 enters state 706 when a query has resulted in a match. In response to this match, sensor node 302 sends a response to a base station that initiated the query. In one embodiment, the response includes sending stored values corresponding to sensor readings that were used to generate the first and second dynamic addresses. These stored values may be sent without control circuit 324 requesting a new reading by sensors 310-312 in sensor node 302. In some embodiments, sensor node 302 may respond by sending all saved values from all sensors in the node.

It is noted that FIG. 7 is one example of states associated with operating a sensor node. In other embodiments, additional states may be included and states may be entered in a different order. For example, in some embodiments, states 702 and 703 may be combined to perform both comparisons in parallel, with a following state that determines if the “AND” operation is satisfied.

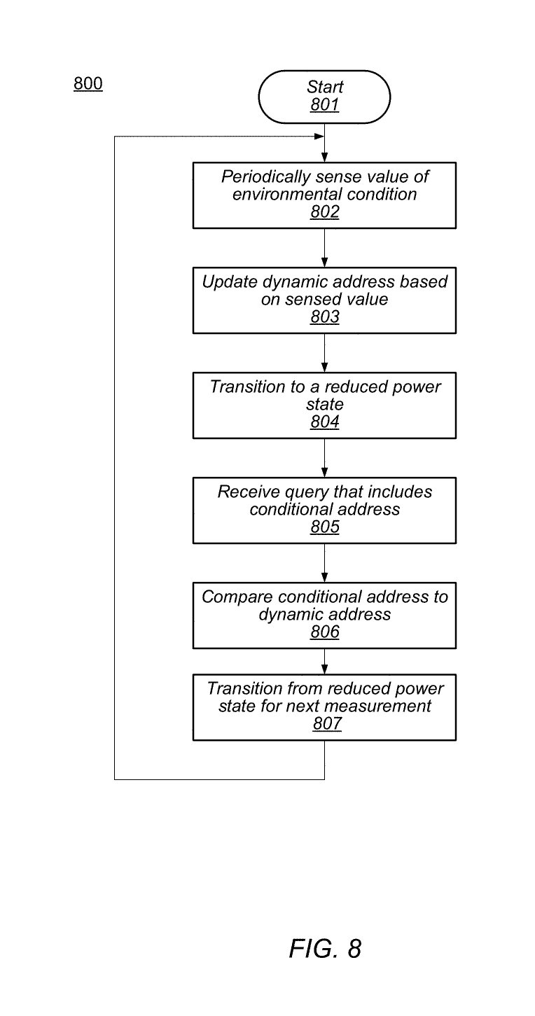

Proceeding to FIG. 8, a flow diagram for an embodiment of a method for operating a sensor node is illustrated. Method 800 may be applied to a sensor node such as, for example, sensor node 302 in FIG. 3. Referring collectively to FIG. 3 and the flow diagram in FIG. 8, the method begins in block 801.

A sensor node periodically senses a value of an environmental variable (block 802). In the illustrated embodiment, a sensor circuit in a sensor node, such as, for example, any of sensors 310-312 in sensor node 302 periodically performs a measurement of a particular environmental variable while in a first power state. As disclosed above in regards to FIG. 1, an environmental variable may refer to any type of physical condition or state that may be measured by an electronic sensing circuit. In some embodiments, each of sensors 310-312 may perform a measurement at a periodic time interval while in the first power state. In other embodiments, one sensor, such as, e.g., sensor 310, may perform the periodic measurement and sensors 311 and 312 may conditionally perform measurements based on the current value measured by sensor 310.

The sensed value may be stored in a memory location that is accessible by communication interface 306.

A control circuit updates a dynamic address based on the sensed value (block 803). Control circuit 324 in communication interface 306 reads the sensed value and updates a dynamic address using the sensed value. In some embodiments, the sensed value may be incorporated directly into the address as shown in FIG. 3 in which one of dynamic addresses 321 includes the value “42” that was sensed by sensor 310. In other embodiments, a process, look-up table, or other algorithm may be used to convert the sensed value into an address. Referring to FIG. 4, for example, control circuit 324 may utilize temperature mapping table 425 to generate dynamic address 421 using the sensed value.

The sensor node transitions to a reduced power state after updating the dynamic address (block 804). In the illustrated embodiment, each of sensors 310-312 may enter the reduced power state after their corresponding dynamic address has been updated. In this reduced power state, sensors 310-312 may not be operable for performing measurements. The reduced power state, however, may result in a longer battery life for battery-powered nodes. While sensors 310-312 are in the reduced power state, communication interface 306 may be in an operable, or semi-operable state. For example, communication interface 306 may remain in a reception mode or “sniff” mode in which a transmission by the base station may be detected. After detecting a transmission, communication interface 306 may enter a fully operational receiver state to detect and receive a query.

The sensor node receives a query that includes a conditional address (block 805). Communication interface 306 receives, in the illustrated embodiment, a query from a base station. The query includes at least one conditional address. This conditional address may include a type of environmental variable, a value for the environmental variable, and a condition that must be true for the conditional address to match the dynamic address. For example, a conditional address may correspond to temperatures greater than 30° C., air pressure less than one bar, or velocity equal to 100 kilometers per hour.

The sensor node compares the conditional address to the dynamic address (block 806). In the illustrated embodiment, control circuit 324 determines which, if any, of dynamic addresses 321 correspond to type of environmental variable included in the received conditional address. A value in the corresponding dynamic address is compared to a value in the conditional address. Control circuit 324 determines if the values of the dynamic and conditional addresses match based on the condition included in the conditional address. If, for example, the conditional address corresponds to a temperature greater than 30° C., then the comparison is true, and a match determined, if the value in the dynamic address corresponds to a temperature above 30° C., and false, i.e., no match, otherwise.

The sensor node transitions from the reduced power state to the first power state (block 807). When a current time period elapses and it is time for a next sensor measurement, control circuit 324 causes one or more of sensors 310-312 to transition from the reduced power state and back into the first power state. In some embodiments, sensor node 302 may utilize one of several power states when performing a sensing operation. In such embodiments, sensor node 302 may enter any one of the power states that enables at least one of sensors 310-312 to perform a sensing operation. Once the appropriate sensors 310-312 are in an appropriate power state, the method returns to block 802 to sense a next value and repeat the disclosed process.

It is noted that method 800 in FIG. 8 is an example embodiment. Variations of the example embodiment are contemplated and may include additional operations. In other embodiments, some operations may be performed in parallel or in a different sequence.

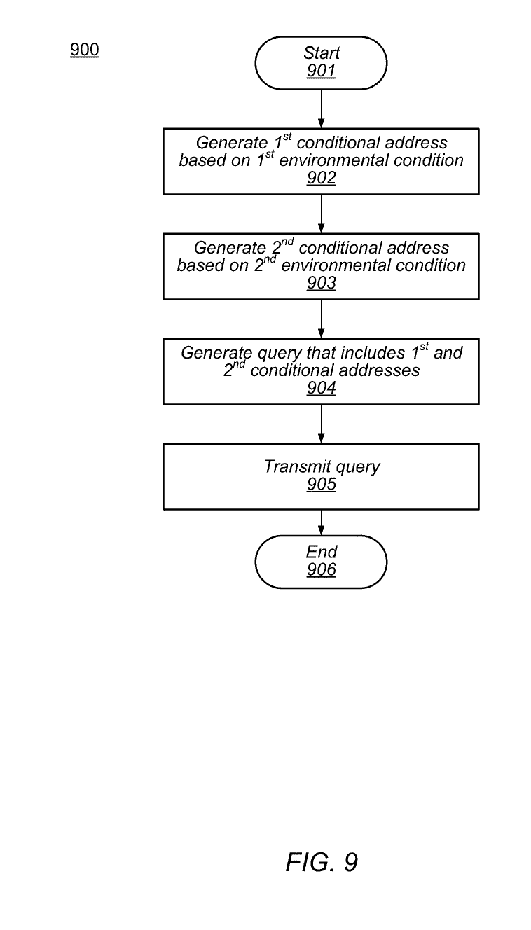

Moving now to FIG. 9, a flow diagram for an embodiment of a method for generating a query by a base station is presented. Method 900 may be applied to a base station such as, for example, base station 101 in FIG. 1, or base station 201 in FIG. 2. A query such as, e.g., query 630a in FIG. 6 may be generated by method 900. Referring collectively to FIGS. 1 and 6, as well as the flow diagram in FIG. 9, the method begins in block 901.

A base station generates a first conditional address based on a first environmental variable (block 902). In the illustrated embodiment, base station 101 determines a conditional addressed based on a particular environmental variable. Returning to the crop irrigation example presented in regards to FIG. 2, base station 101 may be interested in sensor nodes with a humidity reading above 50%. A suitable conditional address may correspond to conditional address 625a, in which the type value of “1001 1011” corresponds to humidity and the value of “0000 0000 1111 1111” may correspond to 50%.

The base station generates a second conditional address based on a second environmental variable (block 903). In addition to humidity, base station 101 may also be interested in sensor nodes with temperatures nearing freezing. In some embodiments, base station 101 may be coupled to the internet or other source of information and, therefore, be capable of receiving weather forecasts. In response to an approaching cold front, base station 101 may identify sensor nodes with near freezing temperatures and high humidity to identify fields where irrigation lines can be shut off to avoid creating ice on the crops. A suitable conditional address for identifying corresponding sensor nodes may correspond to conditional address 625b. In this example, the type value for conditional address 625b (“1001 0111”) may correspond to temperature and the value (“0000 0000 0111 1111”) may correspond to 0° C.

The base station generates a query based on the first and second conditional addresses (block 904). In the illustrated embodiment, base station 101 may add appropriate comparator values to each conditional address to create query 630a. For conditional address 625a, a comparator value of “101” is used to indicate a greater than operation for the humidity value. The “1” in the most significant bit location further indicates that query 630a includes an additional conditional address, in this case, the temperature condition. A comparator value of “1” is added to the end of conditional address 625a to indicate that both conditional address 625a and conditional address 625b must be true for a sensor node to successfully match query 630a. Conditional address 625b is added to query 630a, including a comparator operator of “000” to indicate a less than operation for the temperature value.

The base station transmits the query (block 905). Base station 101, after generating query 630a, transmits the query to sensor nodes within a network of base station 101. In some embodiments, base station 101 may wait for a particular time interval before transmitting query 630a. For example, the sensor nodes may wake at a predetermined time period to sense for a transmission from base station. In such embodiments, base station 101 waits until a beginning of a next particular time period to transmit query 630a. In other embodiments, base station 101 may transmit query 630a once the query has been completed and is in a transmitter buffer. The method ends in block 906).

It is noted that the method of FIG. 9 is merely an example. In other embodiments, some operations may be performed in parallel or in a different sequence. Additional operation may be included in some embodiments.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. An apparatus comprising:
a sensor circuit configured to periodically sense a value for a particular environmental variable; and
a wireless communication interface, coupled to the sensor circuit, configured to:
in response to receiving an updated sensed value for the particular environmental variable from the sensor circuit, update a current value for a dynamic address for the apparatus based on the updated sensed value;
after updating the current value for the dynamic address, receive a query from a base station, wherein the query includes a conditional address corresponding to the particular environmental variable; and
in response to a first comparison of the conditional address to the current value of the dynamic address, send a reply to the base station indicating whether the query has matched for the apparatus, wherein the reply to the query is performed without requesting a reading of the particular environmental variable from the sensor circuit.

2. The apparatus of claim 1, wherein the query further includes a comparator value indicating a type of comparison operation to be performed to determine whether the query matches for the apparatus, and wherein to compare the conditional address to the current value of the dynamic address, the wireless communication interface is further configured to compare at least a portion of the conditional address to the current value of the dynamic address using the comparison operation.

3. The apparatus of claim 1, wherein the wireless communication interface is further configured to include an identifier, including a static address, for the apparatus in the reply.

4. The apparatus of claim 1, wherein the wireless communication interface is further configured to include a value indicating the updated sensed value in the reply.

5. The apparatus of claim 1, wherein the wireless communication interface is further configured to:
update a current value for a different dynamic address for the apparatus based on a different periodically sensed value for a different environmental variable; and
compare a different conditional address to the different dynamic address, wherein the query includes the different conditional address that corresponds to the different environmental variable.

6. The apparatus of claim 5, wherein the query corresponds to a compound query that includes a value indicating that the query is a match if the conditional address corresponds to the current value of the dynamic address and the different conditional address corresponds to the different dynamic address.

7. The apparatus of claim 5, wherein the query corresponds to a compound query that includes a value indicating that the query is a match if either particular received address corresponds to the current value of the dynamic address or the different received address corresponds to the different dynamic address.

8. An apparatus comprising:
a processor circuit configured to:
generate a first conditional address based on a value for a particular environmental variable by using the value for the particular environmental variable to reference the value of the first conditional address in a table; and
generate a second conditional address based on a value for a different environmental variable by using the value for the different environmental variable to reference the value of the second conditional address in a table; and
a wireless communication interface, coupled to the processor circuit, configured to transmit a query that includes the first conditional address, the second conditional address, and at least one comparator value indicating a type of comparison operation to be performed to determine whether the query is considered a match.

9. The apparatus of claim 8, wherein the query includes at least:
a first comparator value specifying a first comparison operation using the first conditional address;
a second comparator value specifying a second comparison operation using the second conditional address; and
a third comparator value that indicates a Boolean operation to be performed on results of the first and second comparison operations to indicate a match.

10. The apparatus of claim 8, wherein the wireless communication interface is further configured to receive at least one reply to the query within a particular time period from transmitting the query.

11. The apparatus of claim 10, wherein the processor circuit is further configured to:
within the particular time period, receive a reply that includes an identifier of a sensor node that sent the reply,
use the identifier and a list of sensor nodes to determine a location of the sensor node.

12. The apparatus of claim 11, wherein the processor circuit is further configured to:
select a control node based on identifier of the sensor node; and
send a command to the selected control node.

13. The apparatus of claim 8, wherein the processor circuit is further configured to determine the value for the particular environmental variable and the value for the different environmental variable based on previously received messages.

14. The apparatus of claim 8, wherein the query further includes an indication of an amount of time until a next query will be transmitted, and wherein the wireless communication interface is further configured to receive a reply that includes a proposal for a different amount of time until the next query will be transmitted.

15. A method, comprising:
sensing, by a sensor node, a value for a particular environmental variable;
updating, by the sensor node, a value of a dynamic address based on the sensed value;
after updating the value of the dynamic address, transitioning, by the sensor node, from a first power state to a reduced power state in which the sensor node is not configured to sense the particular environmental variable;
while in the reduced power state:
receiving, by the sensor node, a query from a base station, wherein the query includes a conditional address corresponding to the particular environmental variable; and
comparing, by the sensor node, the conditional address to the updated value of the dynamic address to determine whether the sensor node matches the query; and
in response to determining that the conditional address matches the updated value of the dynamic address, transitioning, by the sensor node, from the reduced power state to the first power state in order to subsequently sense another value for the particular environmental variable.

16. The method of claim 15, wherein the query further includes a comparator value indicating a type of comparison operation to be performed to determine whether the query matches, and wherein comparing the conditional address to the updated value of the dynamic address includes comparing at least a portion of the conditional address to the updated value of the dynamic address using the comparison operation.

17. The method of claim 15, further comprising, based on a result of the comparing, sending, while the sensor node is in the reduced power state, a reply to the query, wherein the reply includes a value corresponding to an identifier for the sensor node.

18. The method of claim 15, further comprising, based on a result of the comparing, sending a reply to the query, the reply including the sensed value of the particular environmental variable without requesting another sensing of the particular environmental variable.

19. The method of claim 15, further comprising sensing another value for a different environmental variable, wherein the query includes a second conditional address corresponding to the different environmental variable, and wherein the comparing further includes a comparison of the second conditional address to a second dynamic address based on the another value.

20. The method of claim 19, further comprising sending a reply in response to a determination that the conditional address and the updated value of the dynamic address match and that the second conditional address and the second dynamic address match.
